(19) United States
(12) Patent Application Publication
(10) Pub. No.: US 2016/0192680 A1
(43) Pub. Date: Jul. 7, 2016

(54) NECTAR FOR BIRDS

(71) Applicant: Canadian Wildlife Federation Inc./Fédération Canadienne de la Faune Inc., Kanata (CA)

(72) Inventor: Deborah A. MCWILLIAMS, Guelph (CA)

(73) Assignee: Canadian Wildlife Federation Inc./Fédération Canadienne de la Faune Inc., Kanata (CA)

(21) Appl. No.: 14/942,264

(22) Filed: Nov. 16, 2015

Related U.S. Application Data
(60) Provisional application No. 62/080,671, filed on Nov. 17, 2014.

(51) Int. Cl. A23K 1/16

(52) U.S. Cl. CPC A23K 1/1643; A23K 1/1751; A23K 1/175; A23K 1/1618; A23K 1/182

(57) ABSTRACT

The invention relates to feed for birds. In particular, the invention relates to types of nectar for consumption by obligate nectarivore and facultative nectarivore birds.

This application claims priority based on U.S. Patent Application No. 62/080,671 entitled “NECTAR FOR BIRDS” filed Nov. 17, 2014, which is herein incorporated by reference.

### FIELD OF INVENTION

The invention relates to feed for birds. In particular, the invention relates to types of nectar for consumption by obligate nectarivore and facultative nectarivore birds.

### BACKGROUND

Bird species that feed upon nectar can be defined as obligate nectarivores or facultative nectarivores. Obligate nectarivores have diets primarily of nectar and cannot survive without nectar in their diets (nectar is essential). Facultative nectarivores ingest nectar as part of their diet, but they can survive without nectar in their diet (nectar is not essential). Hummingbirds are obligate nectarivores and species such as orioles and warblers are facultative nectarivores.

Obligate nectarivores are often hummingbird species that include Anna's, black-chinned, calliope, ruby-throated, and the rufous hummingbird. Wild hummingbirds can live as long as 12 years, but many species are threatened due to habitat degradation. Greater than 15% of hummingbird species are vulnerable to extinction due to habitat degradation. There is therefore a need for a nectar product that is suitable for obligate nectarivores such as hummingbirds, to support hummingbird populations as much as possible.

Facultative nectarivores include orioles (Baltimore, Bullock's, common yellow throat and, the northern) and warblers (American redstart, bay-breasted, blackburnian, blackpoll, black-throated blue, black and white, Canada, cape may, magnolia, ovenbird, palm, pine, Tennessee, Wilson's, yellow-breasted chat and, the yellow-rumped). However, many passerine species will opportunistically ingest nectar as part of their diet.

### SUMMARY OF THE INVENTION

By considering the wild feeding ecology and physiology of obligate and facultative nectarivores, it is possible to derive nectar formulations that are well-suited to support each such type of bird. In particular, it is possible to derive nectar formulations comprising a balanced blend of different sugars that closely approximates the average amounts of such sugars that birds obtain from a variety of different natural nectar sources. Such nectars are attractive to the birds for which they are intended and support the nutritional requirements of birds.

As well, upon considering the wild feeding ecology of birds, it is becomes apparent that electrolytes are an important component of the diets of birds. A nectar formulation can be derived that includes sufficient electrolytes to meet the dietary needs of birds.

In one embodiment, there is provided a nectar for obligate nectarivore birds, comprising substantially: 60% by dry weight sucrose; 20% by dry weight fructose; 18.8% by dry weight glucose; 0.4% by dry weight potassium; 0.3% by dry weight chlorine; 0.3% by dry weight ascorbic acid; and 0.2% by dry weight sodium. There also is provided a powdered, water-soluble mix for obtaining said nectar by combining the mix with water.

In another embodiment, there is provided a nectar for facultative nectarivore birds, comprising substantially: 50% by dry weight glucose; 40% by dry weight fructose; 8.8% by dry weight sucrose; 0.4% by dry weight potassium; 0.3% by dry weight chlorine; 0.3% by dry weight ascorbic acid; and 0.2% by dry weight sodium. There also is provided a powdered, water-soluble mix for obtaining said nectar by combining the mix with water.

### DESCRIPTION OF EMBODIMENTS OF THE INVENTION

Particular embodiments of the present invention will now be described in greater detail. In so doing, reference will be made to the following sources:
Ackermann M & Weigend M. 2006. Nectar, floral morphology and pollinator syndrome in Loasaceae subfamily Loasoideae (Cornales). Annals of Botany, 98: 503-514.
Baker I & Baker H G. 1976. Analysis of amino acids in flower nectars of hybrids and their parents, with phylogenetic implications. New Phytolologist, 76: 87-98.
Baker H G & Baker I. 1982a. Chemical constituents of nectar in relation to pollination mechanisms and phylogeny. In: Biochemical Aspects of Evolutionary Biology, Nitecki M H (ed), University of Chicago Press, Chicago, Ill., U.S.A, pp. 131-171.
Baker I & Baker H G. 1982b. Some chemical constituents of floral nectars of Erythrina in relation to pollination and systematics. Allertonia, 3: 25-37.
Baker H G, Baker I & Hodges S A. 1998. Sugar composition of nectar and fruits consumed by birds and bats in the tropics and sub-tropics. Biotropica, 30: 559-586.
Bent A C. 1940. Life histories of North American cuckoos, goat suckers, hummingbirds and their allies. U.S. National Museum Bulletin, 176, Washington, D.C.
Beuchal C A & Chong C R. 1998. Hyperglycemia in hummingbirds and its consequences for hemoglobin glycation. Comparative Biochemistry and Physiology A, 120: 409-416.
Blem C R et al. 2000. Rufous hummingbirds sucrose preference: precision of selection varies with concentration. The Condor, 102: 235-238.
Blem C R, Blem L B & Cosgrove C C. 1997. Field studies of rufous hummingbird sucrose preference—does source height affect test results. Journal of Field Ornithology, 68(2): 245-252.
Brice A T. 1992. The essentiality of nectar and arthropods in the diet of Anna's hummingbird (Calypte anna). Comparative Biochemistry and Physiology, 101A(1): 151-155.
Brice A T, Dahl K H & Grau C R. 1989. Pollen digestibility by hummingbirds and psittacines. The Condor, 91: 681-688.
Brice A T & Grau C R. 1989. Hummingbird nutrition: development of a purified diet for long-term maintenance. Zoo Biology, 8: 233-237.
Brice A T & Grau C R. 1991. Protein requirements for maintenance of adult Costa's hummingbird (Calypte costae). Physiological Zoology, 64: 611-626.
Broom D M. 1976. Duration of feeding bouts and response to salt solutions by hummingbirds at artificial feeders. Condor, 78: 135-138.
Brown K J & Downs C T. 2003. Digestion efficiency of a generalist avian feeder, the Cape white-eye (Zosterops pallidus). Comparative Biochemistry and Physiology A, 134: 739-748.
Brown M, Downs C T & Johnson S D. 2009. Pollination of the red hot poker Kniphofia cauliscens by short-billed opportunistic avian nectarivores. South African Journal of Botany, 75: 707-712.
Calder W A. 1994. When do hummingbirds use torpor in nature?Physiological Zoology, 67(5): 1051-1076.
Carpenter F L & Hixon M A. 1988. A new function for torpor: fat conservation in a wild migrant hummingbird. The Condor, 90(2): 373-378.
Carpenter F L, Hixon M A, Hunt A & Russell R W. 1991. Why hummingbirds have such large crops. Evolutionary Ecology, 5: 405-414.
Carroll S P & Moore L. 1993. Hummingbirds take their vitamins. Animal Behaviour, 46: 817-820.
Cecere J G et al. 2011. Nectar: an energy drink used by European song birds during spring migration. Journal of Ornithology, 152: 923-931.
Couter J R et al. 2013. Assessing migration of ruby-throated hummingbirds (Archilochis colubus) at broad spatial and temporal scales. The Auk, 130(1): 107-117.
Cruden R W & Toledo V M. 1977. Oriole pollination of Erythrina breviflora (Leguminosae): evidence for a polytypic view of ornithophily. Plant Systematics and Evolution, 126: 393-403.
Diamond J M et al. 1986. Digestive physiology is a determinant of foraging bout frequency in hummingbirds. Nature, 320: 62-63.
Dress W J et al. 1997. Analysis of amino acids in nectar from pitchers of Sarracenia purpurea (Sarraceniaceae). American Journal of Botany, 84(12): 1701-1706.
Dupont Y L et al. 2004. Evolutionary changes in nectar sugar-composition associated with switches between bird and insect pollination: the Canarian bird-flower element revisited. Functional Ecology, 18: 670-676.
Evangelista D et al. 2010. Hovering energetics and thermal balancing in Anna's hummingbird (Calypte anna). Physiological and Biochemical Zoology, 83(3): 406-413.
Frederick H et al. 2003. Analysis of nectar replacement products and a case of iron toxicosis in hummingbirds. In: Proceedings of the Conference of the Nutrition Advisory Group (NAG), American Zoo and Aquarium Association (AZA) on Zoo and Wildlife Nutrition, pp 38-43.
Galetto L & Bernardello G. 2004. Floral nectars, nectar production dynamics and chemical composition in six Ipomoea species (Convulvulaceae) in relation to pollinators. Annals of Botany, 94: 269-280.
Gartrell B D. 2000. The nutritional, morphologic, and physiologic basis of nectarivory in Australian birds. Journal of Avian Medicine and Surgery, 14(2): 85-9.
Gass C L & Montgomerie R D. 1981. Hummingbird foraging behavior: decision-making and energy regulation. In: Foraging Behavior: Ecological, Ethological and Psychological Approaches, Kamil A C & Sargent T D (eds.), Garland STPM Press, New York, U.S.A., pp 159-199.
Gass C L, Romich M & Suarez R K. 1999. Energetics of hummingbird foraging at low ambient temperature. Canadian Journal of Zoology, 77: 314-320.
Gatica C D L et al. 2006. On the relationship between sugar digestion and diet preference in two Chilean avian species belonging to a Muscicapoidea superfamily. Revista Chilena le Historia Natural, 79(3): 287-294.
Godoz L A, Tell L A & Ernest H B. 2014. Hummingbird health: pathogens and disease conditions in the family Trochilidae. Journal of Ornithology, 155: 1-12.
Gottsberger G, Shrauwen J & Linskens H F. 1984. Amino acids and sugars in nectar, and their putative evolutionary significance. Plant Systematics and Evolution, 145: 55-77.
Hainsworth F R. 1973. On the tongue of a hummingbird: its role in the rate and energetics of feeding. Comparative Biochemistry and Physiology, 46A: 65-78.
Hainsworth F R & Wolf L L. 1976. Nectar characteristics and food selection by hummingbirds. Oecologia, 25: 101-113.
Hamerton A E. 1934. Report on deaths occurring in the Society's gardens during the year 1933. Proceedings of the Zoological Society of London, 104: 389-422.
Hamerton A E. 1935. Report on deaths occurring in the Society's gardens during the year 1934. Proceedings of the Zoological Society of London, 105: 389-422.
Hargrove J L. 2005. Adipose energy stores, physical work and the metabolic syndrome: lessons from hummingbirds. Nutrition Journal, 4: 36-40.
Hardesty J. 2009. Using nitrogen-15 to examine protein sources in hummingbird diets. Ornitologia Columbiana 8: 19-28.
Heibart S M & Calder III W A. 1983. Sodium, potassium, and chloride in floral nectars: energy-free contributions to refractive index and salt balance. Ecology, 64(2): 399-402.
Heinemann D. 1992. Resource use, energetic profitability, and behavioral decisions in migrant rufous hummingbirds. Oecologia, 90: 137-149.
Heyneman A J. 1983. Optimal sugar concentration of floral nectar—dependence on sugar intake efficiency and foraging costs. Oecologia, 60: 198-213.
Hixon M A & Carpenter F L. 1988. Distinguishing energy maximization from time minimization: a comparative study of two hummingbird species. American Zoologist, 28: 913-925.
Hixon M A, Carpenter F L & Paton D C. 1983. Territory area, flower density and time budgeting in hummingbirds: an experimental theoretical analysis. American Naturalist, 122: 366-391.
Hornung-Leoni, González-Gómez P L & Troncoso A J. 2013. Morphology, nectar characteristics and avian pollinators in five Andean Puya species Acta-Oecologia, 51: 54-61.
Inouye D W et al. 1980. The effects of nonsugar nectar constituents on estimates of nectar energy content. Ecology, 61(4): 992-996.
Inouye D W, Calder W A & Waser N M. 1991. The effect of floral abundance on feeder censuses of hummingbird populations. The Condor, 93: 279-285.
Johnson S D, Hargreaves A L & Brown M. 2006. Dark, bitter-tasting nectar functions as a filter of flower visitors in a bird-pollinated plant. Ecology, 87(11): 2709-2716.
Jolls C L et al. 1994. Spectrophotometric analysis of nectar production in Silene vulgaris (Caryophyllaceae). American Journal of Botany, 81(1): 60-64.
Kaczorowski R L et al. 2005. Nectar traits in Nicotiana section alatcae (Solanaceae) in relation to floral traits, pollinators, and mating system. American Journal of Botany, 92(8): 1270-1283.
Karasov W H et al. 1986. Food passage and intestinal nutrient absorption in hummingbirds. The Auk, 103(3): 453-464.
Kevan P G, St. Helens S D & Baker I. 1983. Hummingbirds feeding from exudates on diseased scrub oak. Condor, 85: 251-252.
Kingsolver J G & Daniel T L. 1983. Mechanical determinants of nectar feeding strategy in hummingbirds: energetics, tongue morphology and licking behavior. Oecologia, 60: 214-226.
Klasing K C. 1998. Comparative Avian Nutrition. CAB International, Wallingford, OX, UK. 350 pp.
Köhlu A et al. 2012. Energy management on a nectar diet: can sunbirds meet the challenges of low temperature and dilute food?Functional Ecology, 24: 1241-1251.
Lanza J, Smith G C & Sack S. 1995. Variation in nectar volume and composition of Impatiens capensis at the individual, plant, and population level. Oecologia, 102: 113-119.
Lasiewski R C. 1963. Oxygen consumption of torpid, resting, active and flying hummingbirds. Physiological Zoology, 36: 122-140.
Lasiewski R C. 1964. The energetics of migratory hummingbirds. The Condor, 64: 324.
Leseigneur C D C & Nicolson S W. 2009. Nectar concentration preferences and sugar intake in the white-bellied sunbird Cinnyris talatala (Nectariniidae). Journal of Comparative Physiology B, 179: 673-679.
Lotz C N & Nicolson S W. 2002. Nectar dilution increases metabolic rate in the lesser double-collared sunbird. The Condor, 104(3): 672-675.
Lotz C N & Schondube J E. 2006. Sugar preferences in nectar- and fruit-eating birds: behavioral patterns and physiological causes. Biotropica, 38(1): 3-15.
MacMillan R E & Carpenter F L. 1976. Daily energy costs and body weight in nectarivorous birds. Comparative Biochemistry and Physiology, 56A: 439-441.
Malcarney H L, Martínez del Rio C & Apanius V. 1994. Sucrose intolerance in birds: simple nonlethal diagnostic methods and consequences for assimilation of complex carbohydrates. The Auk, 111(1): 170-177.
Markman S, Pinshow B & Wright J. 1999. Orange-tufted sunbirds do not feed nectar to their chicks. Auk, 116: 257-259.
Markman S, Pinshow B & Wright J. 2002. The manipulation of food resource reveals sex-specific trade-offs between parental self-feeding and offspring care. Proceedings of the Royal Society London B: 1931-1938.
Martínez del Rio C. 1990. Sugar preferences in hummingbirds: the influence of subtle chemical differences on food choice. The Condor, 92(4): 1022-1030.
Martínez del Rio C & Karasov W H. 1990. Digestion strategies in nectar- and fruit-eating birds and the sugar composition of plant rewards. The American Naturalist, 136(5): 618-637.
Martínez del Rio et al. 2001. Intake response in nectar feeding birds: digestive and metabolic causes, osmoregulatory consequences, and coevolutionary effects. American Zoologist, 41(4): 902-915.
Masierowska M L. 2003. Floral nectaries and nectar production in brown mustard (Brassica juncea) and white mustard (Sinapis alla) (Brassicaceae). Plant Systematics and Evolution, 238: 97-107.
McWhorter T J & Lopez-Calleja M V. 2000. The integration of diet, physiology and ecology of nectar feeding birds. Revista Chilena de Historia Natural, 73: 451-460.
Medina-Tapia N et al. 2012. Do hummingbirds have a sweet-tooth?Gustatory sugar thresholds and sugar selection in broad-bellied hummingbird Cynanthus latirostris. Comparative Biochemistry and Physiology a: 161: 307-314.
Montgomerie R D, Eadie J M & Harder L D. 1984. What do foraging hummingbirds maximize?Oecologia, 63: 357-363.
Napier K R et al. 2013. Sugar preferences of avian nectarivores are correlated with intestinal sucrose activity. Physiological and Biochemical Zoology, 86(5): 499-514.
Nicolson S W. 2002. Pollination by passerine birds: why are nectars so dilute?Comparative Biochemistry and Physiology b, 131: 645-652.
Nicolson S W & Fleming P A. 2003. Nectar as food for birds: the physiological consequences of drinking dilute sugar solutions. Plant systematics and Evolution, 238: 139-153.
Nicolson S W, Hoffman D & Fleming P A. 2005. Short-term energy regulation in nectar-feeding birds: the response of white-bellied sunbirds (Nectarina talatala) to a midday fast. Functional Ecology, 19: 988-984.
Odum E P, Connell C E & Stoddard H L. 1961. Flight energy and estimated flight ranges of some migratory birds. Auk, 78: 515-527.
Ornelas J F et al. 2007. Phylogenetic analysis of interspecific variation in nectar of hummingbird-visited plants. Journal of Evolutionary Biology, 20: 1904-1917.
Paton D C. 1982. The diet of the New Holland honeyeater Philidonyris novaehollandiae. Australian Journal of Ecology, 7: 279-298.
Peaker M. 1990. Nutritional requirements and diets for hummingbirds and seabirds. International Zoo Yearbook, 29: 109-119.
Pearson O P. 1954. The daily energy requirements of a wild Anna's hummingbird. Condor, 56: 317-322.
Pender R J, Morden C W & Paull R E. 2014. Investigation of the pollination syndrome of the Hawaiian genus Clermontia (Campanulaceae) using floral nectar traits. American Journal of Botany, 101(1): 201-205.
Perret et al. 2001. Nectar sugar composition and pollination syndromes in Sinningieae (Gesneriaceae). Annals of Botany, 87: 267-273.
Petanidou T et al. 2006. What shapes amino acid and sugar composition in Mediterranean floral nectars. Oikos, 115: 155-169.
Phillips A R. 1975. The migration of Allen's and other hummingbirds. Condor, 77: 25-32.
Pike G H & Waser N M. 1981. The production of dilute nectars by hummingbird and honeyeater flowers. Biotropica, 13: 260-270.
Powers D R & Nagy K A. 1988. Field metabolic rate and food consumption by free-living Anna's hummingbirds (Calypte anna). Physiological Zoology, 61: 500-506.
Powers D R & Conley T M. 1994. Field metabolic rate of two sympatric hummingbird species in southeastern Arizona. Condor, 96: 141-150.
Prinzinger R, Liibber I & SchuchmannKL. 1989. Energy metabolism and body temperature in 13 sunbird species (Nectariniidae). Comparative Biochemistry and Physiology, 92A(3): 393-402.
Purchase C, Nicolson S W & Fleming P A. 2013. Salt intake and regulation in two passerine nectar drinkers: white bellied sunbirds and New Holland honeyeaters. Journal of Comparative Biochemistry and Physiology B, 183(4): 501-510.
Ragusa-Netto J. 2002. Exploitation of Erythrina dominguezii Hassl. (Fabacea) nectar by perching birds in a dry forest in western Brazil. Brazilian Journal of Biology, 62(4b): 877-883.
Scharnke H. 1931. Beitrage zur morphologie und entwicklungsgeschichte der zunge der Trochilidae, Meliphagidae und Picidae. Journal of Ornithology, 79: 425-491.
Schmidt-Lebuhn A N et al. 2007. Phylogenetic constraints versus ecology in the nectar composition of Acanthaceae. Flora, 202: 62-69.
Schondube J E & Martínez del Rio C. 2003. Concentration-dependent sugar preferences in nectar-feeding birds: mechanism and consequences. Functional Ecology, 17: 445-453.
Schuchmann K L. 1979. Kolibris-Haltung und Pflege. Biotropic-Verlag, Frankfurt, Germany. 78 pp.
Schwilch R et al. 2001. Nectar consumption of warblers after long-distance flights during spring migration. Ibis, 143: 24-32.
Stiles F G. 1995. Behavioral, ecological and morphological correlates of foraging for arthropods by the hummingbirds of a tropical wet forest. The Condor, 97(4): 853-878.
Stiles F G. 1976. Taste preferences, color preferences, and flower choice in hummingbirds. The Condor, 78(1): 10-26.
Stiles F G & Freeman C E. 1993. Patterns in floral nectar characteristics of some bird-visited plant species from Costa Rica. Biotropica, 25: 191-205.
Stromberg M R & Johnsen P B. 1990. Hummingbird sweetness preferences: taste or viscosity?The Condor, 92(3): 606-612.
Suarez R K et al. 1990. Fuel selection in rufous hummingbirds: ecological implications of metabolic biochemistry. Proceedings of the National Academy of Sciences, 87: 9207-9210.
Suarez R K & Gass C L. 2002. Hummingbird foraging and the relation between bioenergetics and behavior. Comparative Biochemistry and Physiology A, 133: 335-343.
Sutherland S D & Vickery Jr R K. 1993. On the relative importance of floral color, shape and nectar rewards in attracting pollinators to Mimulus. Great Basin Naturalist, 53(2): 107-117.
Tamm S & Gass C L. 1986. Energy intake rates and nectar concentration preferences by hummingbirds. Oecologia, 70: 20-23.
Terrab A et al. 2007. Analysis of amino acids in nectar from Silene colorata Poiret (Caryophyllareae). Botanical Journal of the Linnean Society, 155: 49-56.
Valido A, Dupont Y L & Olesen J M. 2004. Bird-flower interactions in the Macronesian islands. Journal of Biogeography, 31: 1945-1953.
Vickery Jr R K & Sutherland S D. 1994. Variance and Replenishment of nectar in wild and greenhouse populations of Mimulus. Great Basin Naturalist, 54(3): 212-227.
Wadsworth P F, Jones O N & Puggly S L. 1984. Fatty liver in birds at the zoological society of London U K. Avian Pathology, 13: 231-240.
Wethington S & Finlay N. 2009. Addressing humming bird conservation needs: an initial assessment. In: Proceedings of the Fourth International Partners in Flight Conference: Tundra to Tropics: Connecting Birds, Habitat and People, 13-16 Feb. 2008, McAllen, Texas, U.S.A., pp 662-666.
Witt T et al. 1999. Nectar dynamics and sugar composition in flowers of Silene and Saponaria species (Caryophyllaceae). Plant Biology, 1: 334-345.
Witteveen M, Brown M & Downs C T. 2014. Does sugar content matter?Blood plasma glucose levels in an occasional and a specialist avian nectarivore. Comparative Biochemistry and Physiology, Part A: 167: 40-44.
Wolf L L. 1970. The impact of seasonal flowering on the biology of some tropical hummingbirds. The Condor, 72(1): 1-14.
Wolf L L & Hainsworth F R. 1977. Temporal patterning of feeding by hummingbirds. Animal Behavior, 25: 976-989.

To develop a nectar formulation that is well suited for different types of birds, it is advantageous to study the wild feeding ecology and gastrointestinal physiology of such birds. Wild feeing ecology and physiology of both obligate nectarivores, such as hummingbirds and facultative nectarivores have been studied extensively for decades. Such research can offer insights into advantageous formulations of nectar.

Wild Diet

The wild diets of obligate nectarivores such as hummingbird species include plant nectar, manna (exudate of damaged wood), honeydew (produced by the nymphal stage of aphids), lerp (waxy secretion of plant lice), insects (flies, mosquitoes, wasps, spiders) and, some sand and dirt (thought to provide minerals) (Bent, 1940; Peaker, 1990; Stiles, 1995; Klasing, 1998; Gartrell 2000). Nectar and other plant exudates have minimal amounts of protein or fat and insects provide most of the dietary protein and fat for hummingbird species. Pollen, high in amino acids, is estimated to be approximately 1.7-8.6% of hummingbird diets (Brice et al., 1989), but pollen is only ingested opportunistically while foraging for nectar (Paton, 1982). The digestibility of pollen in hummingbirds is less than 7%, therefore pollen contributes minimal amounts of amino acids to a hummingbird diet (Klasing 1998). Pollen has a limited digestibility because it is covered with indigestible layers of exine and intine that protect the pollen grain (Schwilch et al., 2001).

A three gram hummingbird needs about 1.5% daily diet as protein (DM basis) and this is primarily obtained from insect prey. An average dietary protein level for a hummingbird this size is 28-38 mg daily and this amount can be provided by approximately 28-38 flies at 1 mg per protein per fly (DM basis) (Brice et al., 1989; Brice and Grau, 1991).

Facultative nectarivores use nectar as part of a varied diet and nectar is not essential to their survival. The varied diet includes seeds, fruit, insects and nectar (Witteveen et al., 2014). As a result, their physiology and metabolism as omnivorous species has not attracted the extensive research of hummingbird species.

Facultative nectarivores include a variety of oriole and warbler species (listed above in the introduction) although many passerine species may use nectar as part of their diet. Nectar is a food that is highly digestible and high in energy and is especially used by many migrating passerine species (Schwilch et al., 2001).

### Gastrointestinal Physiology

Hummingbirds have long, thin beaks and tongues with grooves, bristles and papillae that can be extended to lick nectar (Scharnke, 1931; Klasing, 1998). Hummingbirds use their beaks to extract nectar by capillary action and not by sucking. Their tongues have open grooves and nectar (fluid) moves by wicking and the fluid movement is dependent upon the surface tension of the fluid.

Nectar diets are extremely digestible (greater than 90%), therefore the gastrointestinal tract of hummingbirds is only a short, simple system with the ceca either vestigial or absent (Gartrell, 2000). Hummingbirds have relatively large crops and may ingest large meals for overnight digestion (Carpenter et al., 1991), but they typically use only approximately 1/10th crop size (0.5-0.6 ml) per meal (Hixon and Carpenter, 1988). Insects are a high fibre food and digestion is slower with a low digestion efficiency in hummingbirds of only 24% (Klasing 1998).

A nectar meal is cleared from the crop in less than 20 minutes and the gut transit time (GTT) is also less than 20 minutes (Karasov et al, 1986; Beuchal & Chong, 1998). The rapid GTT and digestive efficiency provides readily available carbohydrates to maintain a positive energy balance, yet allows lipid storage (fat reserves) to accumulate to use to survive the night (Beuchal & Chong, 1998).

Nectar is high in water content and hummingbirds produce dilute urine at a volume of three times their body size. Hummingbirds do produce highly dilute urine as compared to many other vertebrate species to conserve ions (Purchase et al., 2013). Producing a high volume of urine means they must replace at least 15% of electrolytes daily (Martínez del Rio et al., 2001). It is therefore apparent that a hummingbird diet must be rich in electrolytes, to ensure that the high volume of electrolytes lost in the urine is replaced.

The typical daily feeding pattern of a hummingbird is to eat every 10 to 20 minutes and rest between meals to digest food from the crop (Beuchal & Chong, 1998). Hover feeding per meal lasts 10-33 seconds and a forage bout is usually less than five minutes. Throughout the day, wild hummingbirds hover 10-35% of their time and perch the remainder of time to digest food from their crop (Hixon et al., 1983; Diamond, 1986). Short forage bouts means only carbohydrates are used for energy and it prevents use of fat stores (Suarez et al., 1990). Nectar intake and meal size is relatively constant daily at constant temperatures if food is not limited (Wolf and Hainsworth 1977; Gass & Montgomery, 1981), although the first meal and last meal of the day are the largest (Gass & Montgomery, 1981). The last meal of the day is digested overnight for energy provision, but hummingbirds also use fat stores and torpor to survive the night (Hargrove, 2005).

Nocturnal torpor (lowered metabolic rate and body temperature) reduces energy use by as much as 99% (Prinzinger et al, 1989) and is used by all hummingbird species regardless of ambient temperature, body mass and environment. The overnight torpor is more important to energy balance than increased food intake during the day (Nicolson et al., 2005). The body temperature of a hummingbird during torpor can go as low as 1° C. above ambient temperature, but it will not go below 12-14° C. (Carpenter & Hixon, 1988). Hummingbirds can also conserve energy by using piloerection (raising or fluffing of feathers), decreasing flying time and by holding feet closer together during flight (McWhorter & Lopez-Calleja, 2000).

Hummingbirds have a high basal metabolic rate (Powers and Nagy, 1988) and ingest food at a rate of approximately 5× their body weight daily (Nicolson et al., 2005). The heart rate of a hummingbird averages 1260 beats per minute with 250 breaths per minute even at rest (Hargrove, 2005). Hummingbird species can deposit fat at a rate of 10% of body weight daily due to an accelerated rate of fatty acid synthesis from glucose (Klasing 1998) and they can gain or lose weight within four hours (Gass et al., 1999). Hummingbirds hover to feed on nectar and hovering uses at least 215 kilocalories per gram body weight per hour (Hainsworth, 1973).

As for facultative nectarivores, since they use nectar as only part of a varied diet, they do not have the high metabolic rate of hummingbirds, nor do they rely upon nocturnal torpor (Prinzinger et al, 1989). The relatively eclectic diet of these species allows them to increase or decrease consumption of a wide variety of foods and they have not developed the energetic physiological constraints of hummingbird species (Nicolson et al., 2005).

### Composition of Wild Nectar

The composition of most plant nectar is composed of sucrose (disaccharide) and hexose (glucose and fructose; monosaccharides) with very minor levels of 11 other sugars (Lotz & Schondube, 2006), free amino acids, vitamins and lipids (Witteveen et al., 2014). In general, 73% of all nectars include sucrose, glucose and fructose; only 4% of nectars have sucrose only; and, 17% of nectars have sucrose with either glucose (11%) or fructose (6%) (Peaker, 1990).

### Nectar Colour

Most wild nectars are clear liquids although the phenols in some nectar appear red-brown in colour. Obligate nectarivores do not feed upon coloured nectars because the phenols have a bitter taste (Johnson et al., 2006).

### Concentration of Sugars

Sugar concentration in nectars varies from 5%-66% and will vary depending on season, weather, time of day and environment (Hainsworth, 1973; Schondube & Martínez del Rio, 2003). The sex of a flower also affects nectar composition and males produce more concentrated nectars (higher in sugars) (Jolls et al., 1994). The concentration of nectar may also differ depending if a plant is wild or greenhouse grown. For example, wild Mimulus species (monkey-flower) range from 12.1-19.9% in total sugars, but greenhouse varieties can range from 13.7-33.1% total sugars (Vicery & Sutherland, 1994).

The concentration of sugars in flower nectar does not vary according to flower colour. Flowers with the colours red, orange, pink, white or yellow had similar levels of sugars in a range of 22.1-26.8% (Ornelas et al., 2007). Therefore, the concentration of a nectar solution offered in an artificial feeder does not have to vary according to the colour of the feeder. Furthermore, it is not necessary to provide an artificial nectar feeder in a colour appropriate to the concentration of the particular nectar being used with the feeder.

Table 1, below provides sugar concentrations for the nectars of various types of plants and flowers:

TABLE 1
Sugar Concentrations in Some Flower Species Used by
Avian Nectarivores

| | % Sugars | Sucrose | Fructose | Glucose |
|---|---|---|---|---|
| Plant/Flower | Wet weight | % total sugar | % total sugar | % total sugar |
| Aster | 20.3⁸ | — | — | — |
| (order: | | | | |
| Asterales) | | | | |
| Bear | 29.0-32.0¹ | — | — | — |
| Breeches | | | | |
| (Acanthus | | | | |
| sp) | | | | |
| Campion | — | 8.8-83.2⁶ | 12.3-59.6⁶ | 6.9-48.8⁶ |
| (Silene sp) | | | | |
| Espinosilla | 21.0-35.8¹ | — | — | — |
| (Loeselia sp) | | | | |
| Evening | 18.2⁸ | — | — | — |
| primrose | | | | |
| (Oenothera | | | | |
| sp) | | | | |
| Fuchsia | — | 14.5⁴ | 6.0⁴ | 1.4⁴ |
| (Fuchsia sp) | | | | |
| Gloxinia | 10.4-35.9⁹ | 63.0-88.6⁹ | 11.4-28.7⁹ | 1.1-6.2⁹ |
| (Sinningia | | | | |
| sp) | | | | |
| Heather | 20.1⁸ | — | — | — |
| (Calluna, | | | | |
| Erica sp) | | | | |
| Hibiscus | — | 0.3-17.1⁴ | 10.3-12.0⁴ | 1.5-13.0⁴ |
| (Hibiscus sp) | | | | |
| Legumes | 22.1⁸ | — | — | — |
| (Family: | | | | |
| Fabaceae) | | | | |
| Lobelia | 19.0-27.0¹, | — | — | — |
| (Lobelia sp) | 19.9⁸ | | | |
| Mint | 24.1⁸ | — | — | — |
| (Family: | | | | |
| Lamiaceae) | | | | |
| Moonflower | — | 62.1-87.2² | 8.8-20.4² | 4.0-16.4² |
| (Ipomoea sp) | | | | |
| Morning | 30.4⁸ | 50.7-78.7² | 7.5-21.2² | 11.0-28.1² |
| Glories | | | | |
| (Ipomoea sp) | | | | |
| Mustard | 31.6-37.9⁵ | — | — | — |
| (Brassica ap) | | | | |
| Oak | 87.2³ | — | — | — |
| sap (Quercus | | | | |
| sp) | | | | |
| Salvia | 20.0-31.0¹ | — | — | |
| (Salvia sp) | | | | |
| Tobacco | 47.6-59.5⁷ | — | — | — |
| plant | | | | |
| (Nicotiana | | | | |
| sp) | | | | |
| Trumpet | 16-32¹ | — | — | — |
| Flower | | | | |
| (Campsis sp) | | | | |
| Average | 23.3-29.7 | 36.0-61.6 | 9.4-24.7 | 4.3-19.0 |
| Range: | | | | |

¹Heyneman, 1983
²Galetto & Bernardello, 2004
³Kevan et al., 1983
⁴Gottsberger et al., 1984
⁵Masierowska, 2003
⁶Witt et al., 1999
⁷Kaczorowski, 2005
⁸Ornelas et al., 2007
⁹Perret et al., 2001

### Vitamins

Flower nectar has minor levels of vitamins including thiamine, riboflavin, niacin, pantothenic acid, B6, biotin, folic acid and vitamin C (Carroll & Moore, 1993). It is probable that hummingbirds do not need a dietary source of vitamin C like most bird species (Brice and Grau, 1989; Beuchal & Chong, 1998).

It has been found that that hummingbirds preferred artificial nectar solutions with dissolved vitamin and mineral tablets in the solution Carroll and Moore (1993). It was concluded that hummingbirds prefer artificial nectar with added vitamins and minerals, but their research may be confounded by the vitamin and mineral tablets used by the researchers. The researchers used tablets (Shaklee Vita-lea) that contained ingredients other than vitamins and minerals and these ingredients may have affected the choice of the hummingbirds. Some of the other ingredients included fruit flavourings, cellulose, soy lecithin, rice bran and flavonoids.

### Amino Acids

The average amino acid level in nectar is approximately 0.122 mg/ml and this level is considered supplemental only (Hainsworth & Wolf, 1976). The most common amino acids found in nectar are arginine, alanine, serine, threonine, proline and glycine.

### Preferences of Birds

### Concentration of Sugars

One factor that appears to affect a bird's preference for a particular nectar is its concentration. One reason for this appears to be the nectar concentration's effect on the surface tension of the nectar. As mentioned above, hummingbirds extract nectar by capillary action, and movement of nectar by capillary action is dependent on surface tension. The surface tension of the nectar, in turn, is a function of nectar concentration—the higher the nectar concentration, the higher the surface tension and nectar intake can be increased. Therefore, nectar lower in sugar concentration (20-25%) results in a smaller intake (volume) of nectar per feeding and nectar higher in concentration (35-40%) can result in a larger intake (volume) of nectar per feeding (Kingsolver & Daniel, 1983). Therefore, the energy intake per feeding is greater when feeding on nectars with the higher concentrations of sugars because a larger amount of nectar can be obtained per feeding. While a hummingbird would ingest more nectar per feeding when the source is nectar of higher concentration, the hummingbird would need less overall nectar to meet energy needs because nectar of higher concentration would provide more energy relative to the same amount of nectar of a smaller concentration.

Nutrition research with captive hummingbirds indicates they can discriminate between nectars with very small differences in sugar concentrations. As discussed in greater detail below, captive hummingbirds have been shown to prefer nectars having particular types of sugars over other sugars, and the sugar of choice depends on the concentration of the nectar. For example, nectar having glucose was preferred if the nectar was dilute, and nectar having sucrose was preferred if the nectar was concentrated. The physiology of hummingbirds may require them to be selective when feeding on dilute nectars that would be reduced in energy content as compared to more concentrated nectars.

As well, the preference for concentration for hummingbirds appears to be related to the volume of nectar. Hummingbirds preferred lower concentrations of sugars (20-25%) for small volumes of nectar, but selected higher concentrations for larger volumes of nectar (Kingsolver & Daniel, 1983).

Table 2, below shows sugar concentration preferences by hummingbird species. Table 3, below shows sugar concentration preferences by facultative nectarivores.

TABLE 2
Sugar Concentration Preferences by Hummingbird Species

| | Overall | Sucrose | | |
|---|---|---|---|---|
| | Sugar | Concen- | | |
| Order of | Concen- | tration | Rejected | |
| Preference | tration % | Preference % | Sugars | Amino Acid % |
| S > G > F¹ | 23.86 | 10-40² | artificial | 0.003-0.009%⁷ |
| | 14.6-56.3⁷ | 20-25⁵ | sweeteners | |
| SFG > SF > | 34.4⁷ | 64.4⁹ | (aspartame, | |
| S > FG > | 20-70¹² | 54.6-58¹⁰ | saccharin, | |
| SG > F > G³ | | 33+¹¹ | Equal)² | |
| | | Captivity: | | |
| | | 40² | | |
| | | 33-56⁴ | | |
| Average | 23.2-46.1% | 36.4-45.2 | — | 0.003-0.009⁷ |
| Range: | | | | |

¹Stiles, 1976
²Stromberg & Johnson, 1990
³Peaker, 1990
⁴Hainsworth & Wolf, 1976
⁵Tamms & Gass, 1986
⁶Ornelas et al., 2007
⁷Gottsberger et al., 1984
⁸Hiebart & Calder, 1983
⁹Nicolson & Fleming, 2003
¹⁰Baker et al., 1998
¹¹Baker & Baker, 1982b
¹²Blem et al., 1997

TABLE 3
Sugar Concentration Preferences by Facultative Nectarivores

| | Overall Sugar | Glucose | Fructose | Sucrose |
|---|---|---|---|---|
| | Concen- | Concen- | Concen- | Concen- |
| | tration % | tration % | tration % | tration % |
| | 10.4-16.0³ | 40.0-45.0² | 44.0-51.0² | 5.0¹ |
| | 10.0-19.0⁴ | 33.0-53.0⁴ | 33.0-52.0⁴ | 4.0-14.0² |
| | 20.0-20.6⁵ | 45.3-57.7⁶ | 40.2-47.6⁶ | 5.0-33.0⁴ |
| | 10.0-15.0⁷ | | | 14.5⁶ |
| | 8.6-15.1⁸ | | | 11.9⁹ |
| | 14.9⁹ | | | |
| | 10.0-24.0¹⁰ | | | |
| | 32.3¹⁰ | | | |
| | 9.2¹¹ | | | |
| Average | 13.9-18.4 | 50.4-51.9 | 39.1-50.2 | 7.1-16.6 |
| Range: | | | | |

¹Witteveen et al., 2014
²Cruden & Toledo, 1977
³Ornelas JF et at., 2007
⁴Schmidt-Lebuhn et al., 2007
⁵Ragusa-Netto, 2002
⁶Dupont et al., 2004
⁷Nicolson, 2002
⁸Brown et al., 2009.
⁹Ackermann & Weigend, 2006
¹⁰Valido et al., 2004
¹¹Pender et al., 2014

### Discrimination of Sugars

Sucrose, glucose and fructose are chemically similar but research indicates that they are experienced differently by species and individual birds. Hummingbird species can digest sucrose, glucose and fructose equally as efficiently, but they prefer sucrose (Stiles, 1976; Nicolson and Fleming, 2003; Medina-Tapia et al, 2012). Indeed, research indicates that obligate nectarivores such as hummingbirds, when given a choice, will usually select a nectar having the highest sucrose content among all available nectars. All hummingbird species have an enzyme called sucrase that is needed to digest sucrose (Medina-Tapia et al, 2012). Sucrase is the catalyst for the hydrolysis of sucrose (disaccharide) into glucose and fructose (monosaccharides) in the small intestine. Hummingbirds can digest sucrose at 90-100% efficiency (Lotz & Schondube, 2006).

Nutrition research with captive hummingbirds indicates they can discriminate between nectars with very small differences in sugars and concentrations. For example, captive hummingbirds preferred glucose if nectar was dilute and preferred sucrose if nectar was concentrated. At very dilute concentrations, hummingbirds prefer fructose over sucrose, glucose or a 1:1 of glucose:fructose (Medina-Tapia et al., 2012). This reflects the composition of wild nectar because most dilute nectars are highest in hexoses (glucose and fructose) (Leseigneur & Nicolson, 2009). The ability to discriminate sugar concentrations was best at low concentrations (dilute nectars) meaning birds were very selective when offered solutions of 19-21% sugar concentrations, but they were not selective when offered solutions with concentrations of 48-72% (Martínez del Rio et al., 2001). As mentioned above, the physiology of hummingbirds may require them to be selective when feeding on dilute nectars that would be reduced in energy as compared to more concentrated nectars.

With regard to facultative nectarivores, many such birds do not have the sucrase enzyme and either avoid sucrose or feed upon nectars that are low in sucrose (McWhorter & Lopez-Calleja, 2000). Some bird species do have the sucrase enzyme, but the enzyme is not active and efficient at digesting sucrose and they will avoid ingesting foods high in sucrose (Malcarney et al., 1994; Napier et al., 2013). Or, some species such as cedar waxwings appear to have a functioning sucrase enzyme but they prefer hexose (glucose and fructose) (Nicolson & Fleming, 2003). Species in Muscicapidae (flycatcher, wheatear, chat, robin, redstart, thrush, catbird, etc), Sturnidae (starling, myna, etc), mockingbird, thrush and finch species do not have the sucrase enzyme (Nicolson & Fleming, 2003; Schondube & Martínez del Rio, 2003; Lotz & Schondube, 2006.

Lack of the sucrase enzyme (or inefficient functioning of the enzyme) causes sucrose intolerance in birds. Sucrose intolerance is a combination of malabsorption of sucrose due to lack of sucrose and a resulting lack of response in glucose plasma (Malcarney et al., 1994). Lack of the sucrase enzyme may cause undigested sucrose to accumulate in the digestive tract and result in diarrhea (Nicolson & Fleming, 2003).

In view of the sucrose intolerance of many facultative nectarivore species, most such species prefer hexose (glucose and fructose) (Baker & Baker, 1982a; Medina-Tapia et al, 2012) and hexose nectars are also the most dilute (Nicolson, 2002). Some species will select nectars with sugar concentrations as low as 3-4% (Baker et al, 1998). Thrushes & mockingbirds prefer glucose over fructose (Gatica et al., 2006).

### Amino Acids

Artificial nectars with amino acids above 0.122 mg/ml are rejected by hummingbirds unless the sugar concentration is increased to hide the taste (Hainsworth & Wolf, 1976). Hummingbirds given a choice of artificial nectar with amino acids did not find that nectar more attractive than nectars without amino acids (Hainsworth & Wolf, 1976).

### Artificial Nectar Formulations

With the foregoing in mind, various artificial nectar formulations can be developed that are well suited for either hummingbirds or facultative nectarivores. It is effectively impossible to provide artificial nectar that replicates exactly the natural variance in sugar concentrations that birds obtain by feeding on wild nectar sources. This is because birds will naturally feed on nectar from different combinations of plant species, and the sugar concentrations of the available nectar will vary depending on the season, weather conditions and geographic location (plants at higher altitudes have higher sugar concentrations). However, hummingbirds and facultative nectarivores likely obtain, through regular feeding habits, sugars in proportions that fall within certain ranges. It is possible to provide artificial nectar having sugar concentrations that fall within said ranges, and therefore provides nutrition that is approximately equivalent to that which is obtained in the wild. Accordingly, a nectar having sugar concentrations within the average ranges of natural nectars as identified in Table 1 will be suitable for avian nectarivores, as it will provide approximately equivalent nutritional benefits to nectars available in the wild. As well, nectars having sugar concentrations within the ranges preferred by obligate and facultative nectarivores identified in Tables 2 and 3 respectively will appeal to these types of birds.

Furthermore, in view of the wild feeding ecology and physiology of obligate nectarivores discussed above, the following guidelines for an artificial nectar formulation are proposed.

1. The nectar solution should offer more than sucrose: Flower nectars are a combination of sucrose and hexose and the nectar solution should reflect the wild feeding ecology. Solutions of sucrose with hexose have “higher profitability energetically” (Martínez del Rio, 1990).
2. Higher than lower sugar concentration: Hummingbirds prefer a solution with a higher concentration of sugars rather than lower from a feeder. If nectar is offered in small amounts, hummingbirds prefer lower concentrations (20-25%), but they will select solutions with higher concentrations if there is a large volume of nectar such as offered by feeders (Stiles, 1976; Kingsolver & Daniel, 1983). Blem et al., 2000 report that the concentration of nectar is more important than the amount of nectar offered. Solutions with higher concentrations of sugars will offer more metabolic support than dilute nectars. Dilute nectars take longer to digest because more water is processed and excreted (Suarez et al., 2002) and dilute nectars will increase the birds metabolic rate by 15% to process the increase in water (Lotz & Nicolson, 2002). If nectar is highly dilute, the hummingbirds cannot ingest enough to gain energy (Nicolson & Fleming, 2003). In addition, hummingbirds rest more when feeding on nectars with a higher concentration of sugars (McWhorter & Lopez-Calleja, 2000) meaning they use less energy foraging. Nectars higher in concentration also increases the quality of parental care offered to nestlings (Markman et al., 2002).
3. Vary the nectar concentration: It should be possible to increase the concentration of the nectar during cold weather conditions, to provide higher sucrose concentrations during colder weather. Hummingbirds require higher sucrose concentrations at colder temperatures and flowers at higher elevations where the temperatures are lower have higher concentrations of sugars in the nectar than flowers at lower elevations (Suarez et al., 2002). A nectar could be provided in powdered, water soluble form, so that the concentration of the nectar could be varied from season to season and/or during inclement weather.
4. Provision of other nutrients: Nectar from artificial feeders for wild bird species is a supplementary feed and is not intended to be a complete feed. Nor should it be a complete feed. Wild hummingbirds depend upon—and have access to—insect prey for dietary protein, fat and most vitamins and minerals (Brice et al., 1989; Brice and Grau, 1991). Many of the nutrients provided by insect prey include fat-soluble nutrients that are stored in body fat. If an additional source of these nutrients were provided in an artificial nectar product, it is possible that nutrient toxicities can develop resulting in harm to the birds that feed upon the nectar. In the wild feeding ecology of hummingbirds, the role of nectar is primarily to maintain energy balance. Therefore, the design of a supplementary nectar product should duplicate wild ecology by providing primarily energy and not duplicating nutrients that wild birds are obtaining from other food sources.
5. Nectar should include electrolytes (sodium, potassium and chlorine): The high water content of a nectar diet means hummingbirds produce a high volume of urine and must replace 15% of body electrolytes daily (Martínez del Rio et al., 2001). If sodium or salt (NaCl) is added to the formula, it should not be more than 70 mM (0.07 molar) because hummingbirds will avoid higher concentrations (Broom, 1976). In addition to a preference for nectar low in sodium, hummingbirds have a limited capacity to process diets high in electrolytes.
6. Colour: The nectar should be clear and the feeder colour designed to attract hummingbirds (Stiles, 1976).

Accordingly, a nectar having sugar content on a dry matter basis within the following ranges, which are based on the average sugar concentrations available in the wild (shown in Table 1) and the preferences of obligate nectarivores (shown in Table 2) is proposed for such nectarivores, such as hummingbirds:

50-60% sucrose

16-24% fructose

14-20% glucose

0.3-0.5% potassium

0.2-0.4% chlorine

substantially 0.3% ascorbic acid (antioxidant)

0.15-0.25% sodium

In particular, a nectar having the following composition is proposed:

60% sucrose

20% fructose

18.8% glucose

0.4% potassium

0.3% chlorine

0.3% ascorbic acid (antioxidant)

0.2% sodium

As discussed above, research demonstrates that obligate nectarivores, when given a choice, usually select a nectar having the highest sucrose content of all available nectars. Thus, it is advantageous for an artificial nectar to include a much sucrose as possible, within the range of sucrose content found in naturally occurring nectars.

The nectar can be provided to users as a powdered mix, soluble in water. The powdered mix can be produced by obtaining powdered products comprising the components referenced above (i.e., powdered fructose, powdered glucose, etc.), and mixing the components in the correct proportions. It will be appreciated that there are several different dry ingredients available that could be used to obtain a mixture having the components listed above (and in the proportions listed above). For example, potassium could be obtained either from potassium gluconate powder or from potassium chloride powder. As another example, the sodium and chlorine components can be provided by adding an appropriate amount of ordinary table salt (i.e., sodium chloride). Any such possible ingredients can be used to prepare the powdered mix, so long as the composition of the final mixture corresponds to that which is shown above.

As well, it will be appreciated that the amounts of dry ingredients required to arrive at a powdered mix having the composition shown above will vary, depending on the ingredients being used. Therefore, a range of preferred nutrient levels can be used as a guideline to deliver a product appropriate to wild feeding ecology.

To produce the nectar from the powdered mix, varying amounts of water can be added to the mix. A more highly concentrated nectar (for example, 35%-45%) would be advantageous in the spring and late summer/fall, when wild nectars are not as available and weather is volatile with lower temperatures. A less concentrated nectar (for example, 25%) would be appropriate for summer, when flowers are available and temperatures are higher. The nectar can be produced as follows:

25% concentration: mix 250 g of powdered nectar mix with 1 litre of water;

35% concentration: mix 350 g of powdered nectar mix with 1 litre of water;

45% concentration: mix 450 g of powdered nectar mix with 1 litre of water.

Once the solution is mixed, any unused solution should be stored in the refrigerator. Feeders should be cleaned thoroughly before adding or replacing nectar.

Water that has been softened, distilled or de-mineralized can be used to produce nectar from powdered nectar mix. However, these kinds of water may alter the final nutrient composition of the nectar. Softened water has added sodium and potassium from the softening process that would raise the sodium and potassium of the nectar above that of the powdered mix used to prepare the nectar. Distilled water is called an “active absorber” and absorbs carbon dioxide from the environment making it acidic. As such, it is unsuitable for the preparation of nectar using a powdered mix. De-mineralized water increases urine output (diuresis) and increases the elimination of electrolytes in the urine. Hummingbird physiology is already very efficient at doing both, and accelerating these processes further with nectar made from de-mineralized water could be problematic for hummingbirds.

With regard to facultative nectarivores, nectars having sugar contents within the average ranges identified in Tables 1 and 3 will be suitable and attractive to these type of nectarivores, since they will provide sugar content that closely approximates what is naturally available to and preferred by such nectarivores. A nectar having sugar content on a dry matter basis within the following ranges is proposed:

48-52% glucose

38-45% fructose

7-11% sucrose

0.3-0.5% potassium

0.2-0.4% chlorine

substantially 0.3% ascorbic acid (antioxidant)

0.15-0.25% sodium

In particular, a nectar having the following composition is proposed

50% glucose

40% fructose

8.8% sucrose

0.4% potassium

0.3% chlorine

substantially 0.3% ascorbic acid (antioxidant)

0.2% sodium

As with the proposed nectar for obligate nectarivores, the nectar can be provided to users as a powdered mix, soluble in water. The powdered mix can be produced by mixing a variety of different dry ingredients in suitable quantities to produce a final powdered mix having the proportions described above. As is the case with the powdered mix for obligate nectarivore nectar, several different dry ingredients can be used, and the amounts of the ingredients that must be used to obtain the composition described above will vary depending on the particular ingredients being used. A range of preferred nutrient levels can be used as a guideline to deliver a product appropriate to wild feeding ecology.

A more highly concentrated nectar (for example, 20%) would be advantageous in the spring and late summer/fall, when wild nectars are not as available and weather is volatile with lower temperatures. A less concentrated nectar (for example, 10%-15%) would be appropriate for summer, when flowers are available and temperatures are higher. The nectar can be produced as follows:

10% concentration: mix 100 g of powdered nectar mix with 1 litre of water;

15% concentration: mix 150 g of powdered nectar mix with 1 litre of water;

20% concentration: mix 200 g of powdered nectar mix with 1 litre of water.

As with the proposed nectar for obligate nectarivores, once the solution is mixed any unused solution should be stored in the refrigerator. Feeders should be cleaned thoroughly before adding or replacing nectar.

As well, water that has been softened, distilled or de-mineralized can be used to prepare the nectar for facultative nectarivores, but is not recommended.

The proposed nectars offer several advantages to birds that feed on them. The nectars are designed based on known nutrient analyses of wild nectar. The nectars are without colour because wild nectar is without colour and birds that feed upon nectar are attracted to the colour of the flower and not the colour of the nectar. Most wild nectars are a combination of sucrose, glucose and fructose, but hummingbird species (obligate nectarivores) prefer nectars high in sucrose and other bird species (facultative nectarivores) prefer nectars lower in sucrose. In addition, many bird species that are facultative nectarivores lack the sucrase enzyme necessary to digest diets high in sucrose. The nectar formulas can also be varied in concentration according to physiological demands during coldest weather. In addition, the nectar formulas include electrolytes needed when species process diets high in water and nectar is very high in water content.

The proposed nectars also offer several advantages to human users who provide the nectars for birds. The nectars support vulnerable species by providing an appropriate nectar supplement. Many hummingbird species are vulnerable to extinction because of habitat degradation (Beuchal & Chong, 1998; Wethington and Finlay, 2009). Providing an appropriate feed supplement may support these species especially during life stages that require available energy such as migration and breeding (Schwilch et al., 2001; Markman et al., 2002; Cecere et al., 2011). Providing supplementary feed for hummingbird species by artificial feeders increases food availability and reduces mortality (Couter et al., 2013). Supplementary feeding will also contribute to breeding success when it improves or maintains body condition (Markman et al., 2002).

As well, the two nectar products clearly specify if they are appropriate for obligate or facultative nectarivores. Additionally, the nectar products include clear and precise directions for varying the nectar concentration as needed depending on season and weather condition.

Furthermore, the nectars are appropriate for use across Canada. Avian nectarivores ingest nectars that have similar, average nutrient composition across Canada. Therefore, the nectar products can be used in all areas of Canada.

It will be apparent to those of skill in the art that numerous alternative formulations of nectar, other than the example embodiments described above, are possible. For example, the proportions of sugars and other ingredients in the proposed nectars could be varied to a certain degree. Since the nectars are intended as a supplemental feed only, the nectars do not have to provide the total nutritional requirements of birds. Such minor variations in the proportions of ingredients, and all other readily apparent alternatives are intended to be within the scope of the present invention. The scope of the present invention is not intended to be limited to the example embodiments described above, but is defined by the following claims, which are to be given the broadest possible interpretation consistent with the specification as a whole.

1. A powdered, water-soluble mix for making nectar for obligate nectarivore birds, comprising:
sucrose in the range of 50%-60% by dry weight;
fructose in the range of 16%-24% by dry weight;
glucose in the range of 14%-20% by dry weight;
potassium in the range of 0.3%-0.5% by dry weight;
chlorine in the range of 0.2% to 0.4% by dry weight;
substantially 0.3% by dry weight ascorbic acid; and
sodium in the range of 0.15% to 0.25% by dry weight.

2. The mix of claim 1, comprising substantially:
60% by dry weight sucrose;
20% by dry weight fructose;
18.8% by dry weight glucose;
0.4% by dry weight potassium;
0.3% by dry weight chlorine;
0.3% by dry weight ascorbic acid; and
0.2% by dry weight sodium.

3. A nectar for obligate nectarivore birds, obtained by dissolving the mix of claim 1 in water.

4. The nectar of claim 3, wherein the nectar is obtained by mixing one part of the mix with four parts water.

5. The nectar of claim 3, wherein the nectar is obtained by mixing 3.5 parts of the mix with ten parts water.

6. The nectar of claim 3, wherein the nectar is obtained by mixing 4.5 parts of the mix with ten parts water.

7. A powdered, water-soluble mix for making nectar for facultative nectarivore birds, comprising:
glucose in the range of 48%-52% by dry weight;
fructose in the range of 38%-45% by dry weight;
sucrose in the range of 7%-11% by dry weight;
potassium in the range of 0.3%-0.5% by dry weight;
chlorine in the range of 0.2%-0.4% by dry weight;
substantially 0.3% ascorbic acid; and
sodium in the range of 0.15%-0.25% by dry weight.

8. The mix of claim 7, comprising substantially:
50% by dry weight glucose;
40% by dry weight fructose;
8.8% by dry weight sucrose;
0.4% by dry weight potassium;
0.3% by dry weight chlorine;
0.3% by dry weight ascorbic acid; and
0.2% by dry weight sodium.

9. A nectar for facultative nectarivore birds, obtained by dissolving the mix of claim 7 in water.

10. The nectar of claim 9, wherein the nectar is obtained by mixing one part of the mix with ten parts water.

11. The nectar of claim 9, wherein the nectar is obtained by mixing 1.5 parts of the mix with ten parts water.

12. The nectar of claim 9, wherein the nectar is obtained by mixing two parts of the mix with ten parts water.

13. A nectar for obligate nectarivore birds, obtained by dissolving the mix of claim 2 in water.

14. The nectar of claim 13, wherein the nectar is obtained by mixing one part of the mix with four parts water.

15. The nectar of claim 13, wherein the nectar is obtained by mixing 3.5 parts of the mix with ten parts water.

16. The nectar of claim 13, wherein the nectar is obtained by mixing 4.5 parts of the mix with ten parts water.

17. A nectar for facultative nectarivore birds, obtained by dissolving the mix of claim 8 in water.

18. The nectar of claim 17, wherein the nectar is obtained by mixing one part of the mix of claim 8 with ten parts water.

19. The nectar of claim 17, wherein the nectar is obtained by mixing 1.5 parts of the mix of claim 8 with ten parts water.

20. The nectar of claim 17, wherein the nectar is obtained by mixing two parts of the mix of claim 8 with ten parts water.
